(19) United States
(12) Patent Application Publication
(10) Pub. No.: US 2010/0064054 A1
(43) Pub. Date: Mar. 11, 2010

(54) REMOTE FAST FORWARD AND REWIND FUNCTIONALITY FOR CLIENT DEVICES

(75) Inventors: Kent Karlsson, San Francisco, CA (US); Anders Odlund, Trollhattan (SE); Todd Stiers, Berkeley, CA (US); Cedric Fernandes, San Ramon, CA (US); Kay Johansson, Alamo, CA (US)

Correspondence Address: Weaver Austin Villeneuve & Sampson LLP, P.O. BOX 70250, OAKLAND, CA, 94612-0250, US

(73) Assignee: MobiTV, Inc., Emeryville, CA (US)

(21) Appl. No.: 12/207,451

(22) Filed: Sep. 9, 2008

(51) Int. Cl. G06F 15/16

(52) U.S. Cl. 709/231

(57) ABSTRACT

A client device receiving a media stream from a remote content server can fast forward and rewind the media stream without storing the media stream on the client device. In some examples, the client sends index, direction, and speed information to the content server based on desired fast forward and rewind operation. The content server transmits selected sets of frames to the client devices based on the index, direction, and speed information to allow a client to play a fast forward or rewind media stream that provides a user with discernible portions of content.

### TECHNICAL FIELD

The present disclosure relates to remote fast forward and rewind operations on client devices.

### DESCRIPTION OF RELATED ART

Some conventional client devices provide remote fast forwarding and rewind functionality when playing media provided by a server. Media players on computer systems provide users with some limited mechanisms for navigating a media stream. In some instances, a user can select a location from which to begin viewing a video stream. The Real-Time Streaming Protocol (RTSP) provides some limited capabilities for playing media streams at different speeds. For example, a user can select to play a media stream at two times speed to fast forward. However, conventional remote fast forwarding and rewind functions have significant limitations and drawbacks.

Consequently, it is desirable to provide improved techniques and mechanisms for allowing remote fast forward and rewind functionality for client devices.

### BRIEF DESCRIPTION OF THE DRAWINGS

The disclosure may best be understood by reference to the following description taken in conjunction with the accompanying drawings, which illustrate particular embodiments.

FIG. 1 illustrates an exemplary system for use with embodiments of the present invention.

FIG. 2 illustrates one example of a Real-Time Transport Protocol (RTP) packet.

FIG. 3 illustrates one example of an RTP stream.

FIG. 4 illustrates one example of a fast forward stream.

FIG. 5 illustrates one example of a rewind stream.

FIG. 6 illustrates one example of performing fast forward and rewind.

FIG. 7 illustrates one example of a system for processing media streams.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of the Real-Time Transport Protocol (RTP) and the Real-Time Streaming Protocol (RTSP). However, it should be noted that the techniques of the present invention apply to a variations of RTP and RTSP. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

A client device receiving a media stream from a remote content server can fast forward and rewind the media stream without storing the media stream on the client device. In some examples, the client sends index, direction, and speed information to the content server based on desired fast forward and rewind operation. The content server transmits selected sets of frames to the client devices based on the index, direction, and speed information to allow a client to play a fast forward or rewind media stream that provides a user with discernible portions of content.

Example Embodiments

A variety of mechanisms are used to deliver media streams and media clips to devices. In particular examples, a client establishes a session such as a Real-Time Streaming Protocol (RTSP) session. A server computer receives a connection for a media stream, establishes a session, and provides media to a client device. The media includes packets encapsulating frames such as Moving Pictures Expert Group (MPEG) frames. The MPEG frames themselves may be key frames or differential frames. The specific encapsulation methodology used by the server depends on the type of content, the format of that content, the format of the payload, the application and transmission protocols being used to send the data. After the client device receives the media, the client device decapsulates the packets to obtain the MPEG frames and decodes the MPEG frames to obtain the actual media data.

In many instances, a server computer obtains media data from a variety of sources, such as media libraries, cable providers, satellite providers, and processes the media data into MPEG frames such as MPEG-2 or MPEG-4 frames. In particular examples, a server computer may encode six media streams of varying bit rates for a particular channel for distribution to a variety of disparate devices. A client device typically requests a media stream and will not begin playback of a media stream until a certain amount of media stream data has been received.

Because of Digital Rights Management (DRM) concerns, devices are typically not allowed to store significant portions of the actual media. Consequently, client devices typically rely on content server streams to provide prepackaged content. In many instances, client devices have limited functionality with respect to fast forwarding, rewinding, and otherwise navigating media streams.

Some media players merely provide a playback button, stop button, and a scroll bar to select a particular point in a media stream where playback should begin. Typical media players do not provide any fast forward or rewind capabilities other than moving the scroll bar to a forward or backward position. When the scroll bar is moved to a forward a backward position, the client can send an RTSP play command with range information to direct a content server to start transmitting the media stream at a particular time index. In other examples, an RTSP speed command can be used to accelerate playback in the forward or the reverse direction. However, the RTSP speed command significantly increases transmission rates. For example, a forward 2× speed request causes a server to transmit at twice the rate. Similarly, a backward 2× speed request causes a server to transmit frames in the backward direction at twice the rate. However, transmitting at twice the rate, particularly for long periods of time, may strain network resources as well as client device resources. In many instances, client devices may not even be able to process frames transmitted at twice the rate.

Furthermore, merely playing frames backward at 2× speed poses other problems. The techniques and mechanisms of the present invention recognize that media streams are typically transmitted in predicted formats. Frames transmitted later often rely on information provided in key frames provided earlier in a media stream. For example, MPEG frames include I-frames, P-frames, and B-frames. An I-frame is a key frame or intra-frame coded completely by itself. P-frames are predicted frames which require information from a previous I-frame or P-frame. B-frames are bi-directionally predicted frames that require information from surrounding I-frames and P-frames. Simply playing predicted frames backwards without necessary key frame information in many instances leads to extremely poor media quality.

Consequently, the techniques and mechanisms of the present invention provide fast forward, rewind, and navigation capabilities for client devices receiving media from remote content servers. According to various embodiments, the client devices can fast forward, rewind, and otherwise navigate media at a variety of different rates without impacting network bandwidth usage or client device resources. In particular embodiments, the number of frames transmitted to the client device even during fast forward and rewind approximates the number of frames transmitted to the client device during normal playback.

Client processing proceeds without straining resources while a user obtains discernable output during fast forward and rewind. Brief segments of discernible content are played whether during fast forward or rewind, and portions of groups of pictures (GOP) including a key frame followed by several predicted frames are transmitted for playback. In some examples, portions of each GOP are transmitted. In other examples, portions of a subset of all GOPs are transmitted. In particular examples, portions of every other GOP are transmitted for playback, or selected portions of selected GOPs are transmitted for playback. Transmitting only a subset of the frames allows fast forward or rewind at a higher rate while still providing discernible output to a user. According to various embodiments, discernible output comprises a set of frames in a GOP that are played over at least a quarter second or half second. Typical full GOPs are played over 2 to 4 seconds. Non dynamic output such as still screens may be played for shorter periods of time while still being discernible, while rapid action sequences may require longer play in order to be discernible.

According to various embodiments, timing and sequence information in an RTP stream is preserved. In particular embodiments, a client device can not distinguish between regular media data and fast forward or rewind media data.

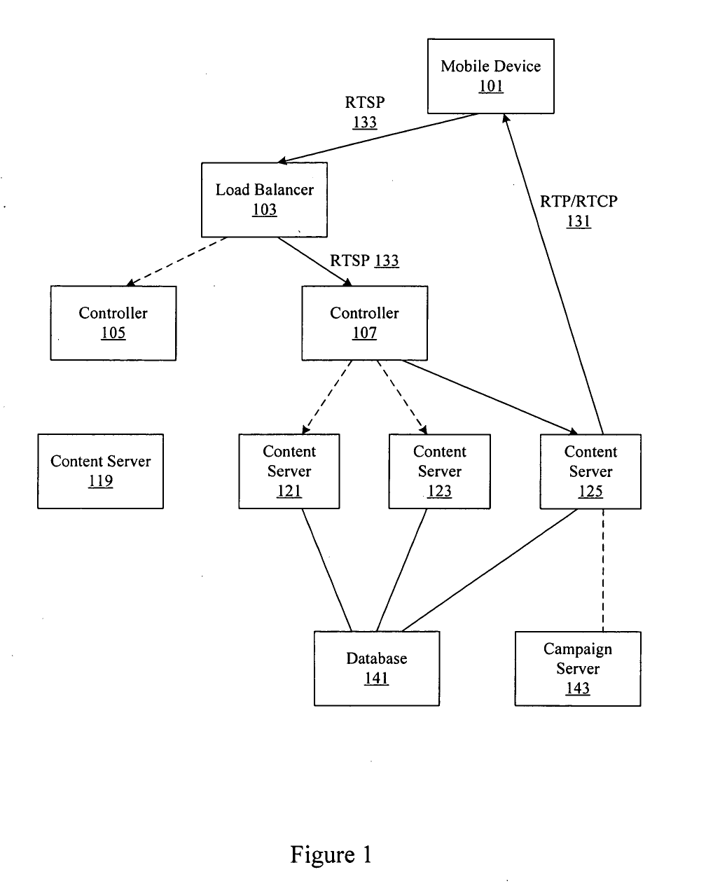

FIG. 1 is a diagrammatic representation illustrating one example of a system that can use the techniques and mechanisms of the present invention. According to various embodiments, content servers 119, 121, 123, and 125 are configured to provide media content to a mobile device 101 using protocols such as RTP and RTCP. Although a mobile device 101 is shown, it should be recognized that other devices such as set top boxes and computer systems can also be used. In particular examples, the content servers 119, 121, 123, and 125 can themselves establish sessions with mobile devices and stream video and audio content to mobile devices. However, it is recognized that in many instances, a separate controller such as controller 105 or controller 107 can be used to perform session management using a protocol such as RTSP. It is recognized that content servers require the bulk of the processing power and resources used to provide media content mobile devices. Session management itself may include far fewer transactions. Consequently, a controller can handle a far larger number of mobile devices than a content server can. In some examples, a content server can operate simultaneously with thousands of mobile devices, while a controller performing session management can manage millions of mobile devices simultaneously.

By separating out content streaming and session management functions, a controller can select a content server geographically close to a mobile device 101. It is also easier to scale, as content servers and controllers can simply be added as needed without disrupting system operation. A load balancer 103 can provide further efficiency during session management using RTSP 133 by selecting a controller with low latency and high throughput.

According to various embodiments, the content servers 119, 121, 123, and 125 have access to a campaign server 143. The campaign server 143 provides profile information for various mobile devices 101. In some examples, the campaign server 143 is itself a content server or a controller. The campaign server 143 can receive information from external sources about devices such as mobile device 101. The information can be profile information associated with various users of the mobile device including interests and background. The campaign server 143 can also monitor the activity of various devices to gather information about the devices. The content servers 119, 121, 123, and 125 can obtain information about the various devices from the campaign server 143. In particular examples, a content server 125 uses the campaign server 143 to determine what type of media clips a user on a mobile device 101 would be interested in viewing.

According to various embodiments, the content servers 119, 121, 123, and 125 are also receiving media streams from content providers such as satellite providers or cable providers and sending the streams to devices using RTP 131. In particular examples, content servers 119, 121, 123, and 125 access database 141 to obtain desired content that can be used to supplement streams from satellite and cable providers. In one example, a mobile device 101 requests a particular stream. A controller 107 establishes a session with the mobile device 101 and the content server 125 begins streaming the content to the mobile device 101 using RTP 131. In particular examples, the content server 125 obtains profile information from campaign server 143.

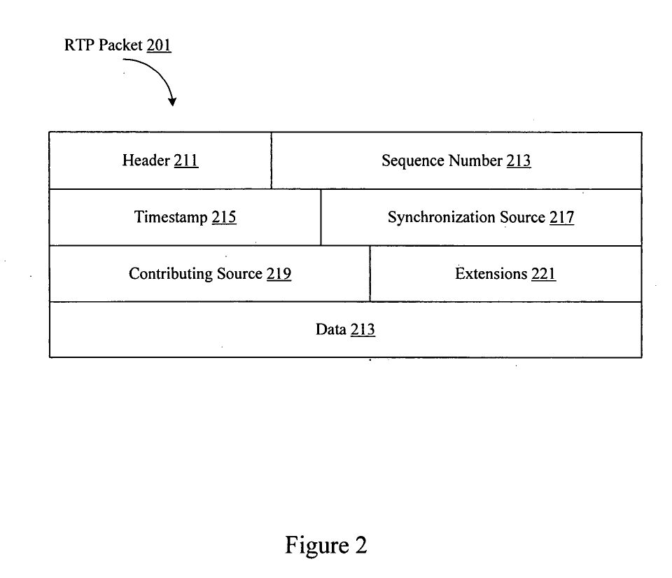

FIG. 2 illustrates one example of an RTP packet. An RTP packet 201 includes a header 211. According to various embodiments, the header 211 includes information such as the version number, amount of padding, protocol extensions, application level, payload format, etc. The RTP packet 201 also includes a sequence number 213. Client applications receiving RTP packets expect that the sequence numbers for received packets be unique. If different packets have the same sequence number, erroneous operation can occur. RTP packets also have a timestamp 215 that allows jitter and synchronization calculations. Fields 217 and 219 identify the synchronization source and the contributing source. Extensions are provided in field 221.

According to various embodiments, data 231 holds actual media data such as MPEG frames. In some examples, a single RTP packet 201 holds a single MPEG frame. In many instances, many RTP packets are required to hold a single MPEG frame. In instances where multiple RTP packets are required for a single MPEG frame, the sequence numbers change across RTP packets while the timestamp 215 remains the same across the different RTP packets. Different MPEG frames include I-frames, P-frames, and B-frames. I-frames are key frames or intraframes coded completely by itself. P-frames are predicted frames which require information from a previous I-frame or P-frame. B-frames are bi-directionally predicted frames that require information from surrounding I-frames and P-frames.

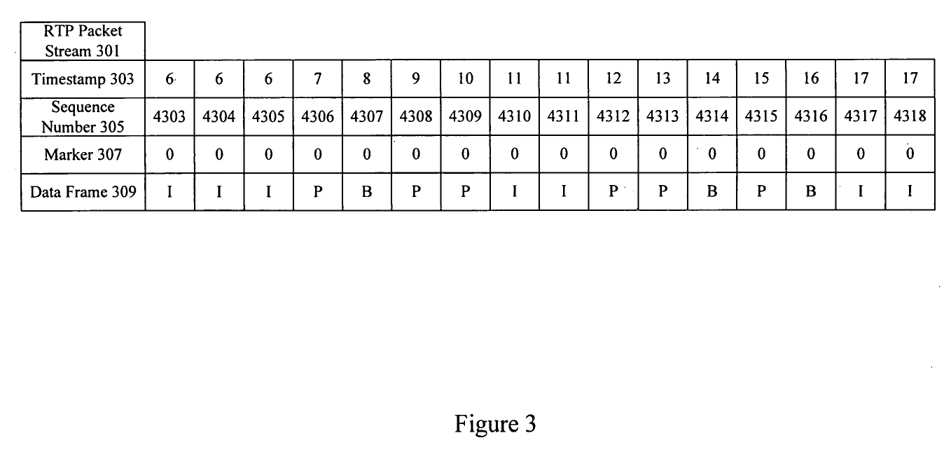

FIG. 3 illustrates one example of an RTP packet stream. An RTP packet stream 301 includes individual packets having a variety of fields and payload data. According to various embodiments, the fields include a timestamp 303, sequence 505, marker 307, etc. The packets also include payload data 309 holding MPEG frames such as I, P, and B-frames. Timestamps for different packets may be the same. In particular examples, several packets carrying portions of the same I-frame have the same time stamp. However, sequence numbers are different for each packet. Marker bits 307 can be used for different purposes, such as signaling the starting point of an advertisement.

According to various embodiments, packets with sequence numbers 4303, 4304, and 4305 carry portions of the same I-frame and have the same timestamp of 6. Packets with sequence numbers 4306, 4307, 4308, and 4309 carry P, B, P, and P-frames and have timestamps of 7, 8, 9, and 10 respectively. Packets with sequence numbers 4310 and 4311 carry different portions of the same I-frame and both have the same timestamp of 11. Packets with sequence numbers 4312, 4313, 4314, 4315, and 4316 carry P, P, B, P, and B-frames respectively and have timestamps 12, 13, 14, 15, and 16. It should be noted that the timestamps shown in FIG. 3 are merely representational. Actual timestamps can be computed using a variety of mechanisms.

For many audio encodings, the timestamp is incremented by the packetization interval multiplied by the sampling rate. For example, for audio packets having 20 ms of audio sampled at 8,000 Hz, the timestamp for each block of audio increases by 160. The actual sampling rate may also differ slightly from this nominal rate. For many video encodings, the timestamps generated depend on whether the application can determine the frame number. If the application can determine the frame number, the timestamp is governed by the nominal frame rate. Thus, for a 30 f/s video, timestamps would increase by 3,000 for each frame. If a frame is transmitted as several RTP packets, these packets would all bear the same timestamp. If the frame number cannot be determined or if frames are sampled a periodically, as is typically the case for software codecs, the timestamp may be computed from the system clock

While the timestamp is used by a receiver to place the incoming media data in the correct timing order and provide playout delay compensation, the sequence numbers are used to detect loss. Sequence numbers increase by one for each RTP packet transmitted, timestamps increase by the time “covered” by a packet. For video formats where a video frame is split across several RTP packets, several packets may have the same timestamp. For example, packets with sequence numbers 4317 and 4318 have the same timestamp 17 and carry portions of the same I-frame.

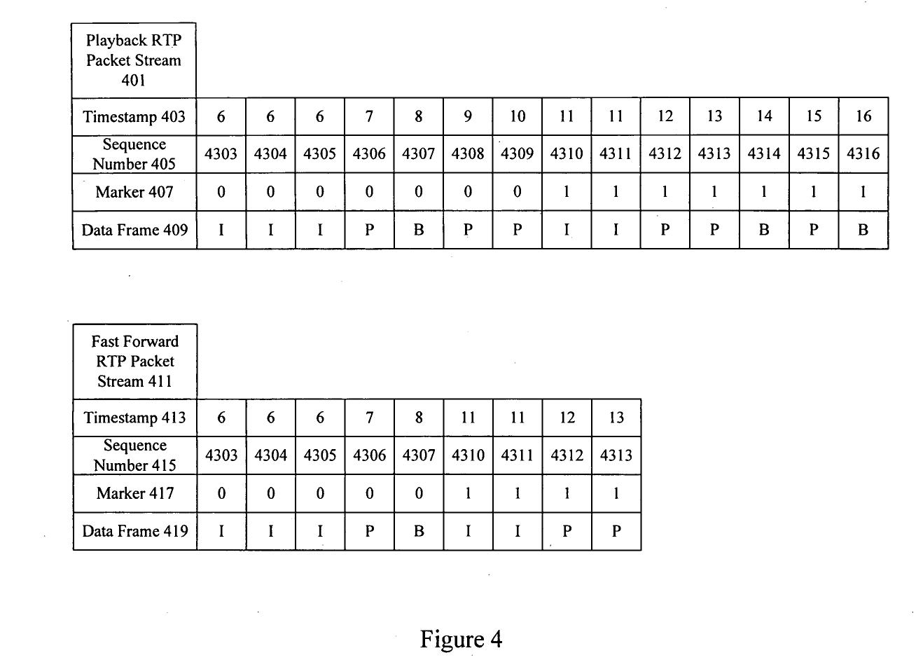

FIG. 4 illustrates one example of a fast forward data stream. According to various embodiments, a content server receives a request to fast forward media data. In particular embodiments, the request is received in an RTSP query command and includes a fast forward rate such as 2×, 4×, 8×, 80×, etc. The content server takes a transmission stream and generates a fast forward stream. According to various embodiments, the fast forward stream includes a portion of each GOP or a portion of a subset of the GOPs in a media stream. In particular embodiments, playback RTP packet stream 401 includes multiple packets having timestamps 403, sequence numbers 405, markets 407, and data portions 409. The packets with time stamps 6, 6, 6, 7, 8, 9, 10, 11, 11, 12, 13, 14, 15, and 16 are associated with timestamps 4303, 4304, 4305, 4306, 4307, 4308, 4309, 4310, 4311, 4312, 4313, 4314, 4315, and 4316. According to various embodiments, each GOP includes a key frame and multiple predicted frames such as P frames and B frames. It should be noted that several packets may be needed to hold a single frame, particular I frames which are larger as they hold data associated with a full picture and not merely differential data.

According to various embodiments, the content server generates a fast forward stream in response to the fast forward request. The fast forward stream 411 includes timestamps 413, sequence numbers 415, markers 417, and data portions 419. The packets with timestamps 6, 6, 6, 7, 8, 11, 11, 12, and 13 are associated with timestamps 4303, 4304, 4305, 4306, 4307, 4310, 4311, 4312, 4313, and 4314. Frames associated with timestamps 9, 10, 14, 15, and 16 are removed. That is, portions of each GOP are removed. Consequently, an 11 frame sequence is reduced to a 6 frame sequence that is run in about half the time. According to various embodiments, the rate is inversely proportional to the GOP size. A 2× fast forward rate reduces each GOP size by half, a 4× fast forward rate reduces each GOP size by a quarter. However, it is recognized that in some instances, portions of GOPs selected for transmission can only be reduced so much in size while still being discernible. According to various embodiments, a portion of a fraction of the GOPs may be transmitted.

According to various embodiments, prior to transmitting the sequence, the timestamps are updated to be sequential. Instead of 6, 6, 6, 7, 8, 11, 11, 12, 13, the timestamps would be 6, 6, 6, 7, 8, 9, 9, 10, 11. Similarly, the sequence numbers are also updated to be sequential. It should be noted that the packets shown are only provided as examples. For example, typical GOPs may include many more predicted frames per key frame than those shown.

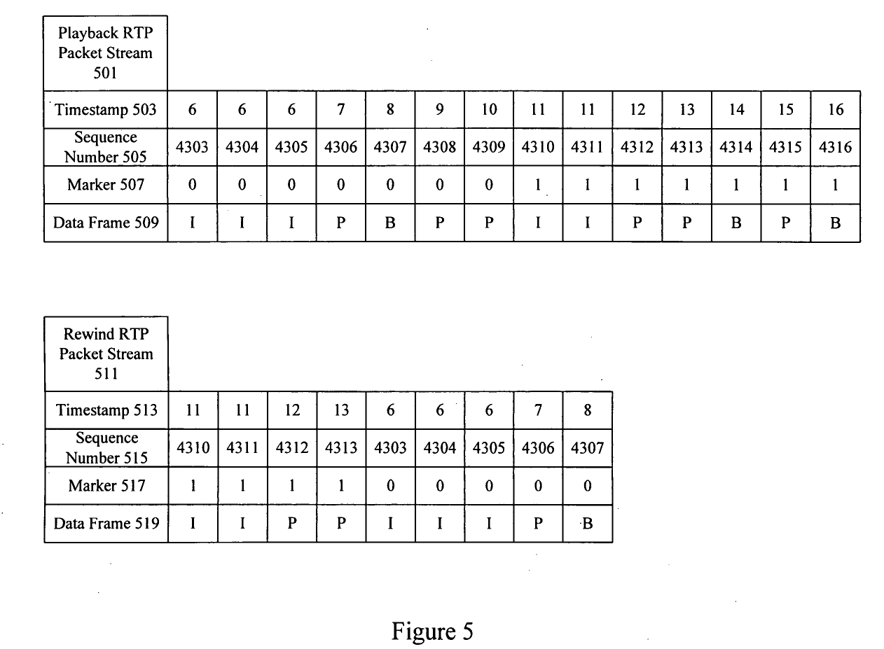

FIG. 5 illustrates one example of a rewind data stream. According to various embodiments, a content server receives a request to rewind media data. In particular embodiments, the request is received in an RTSP query command and includes a rewind rate such as 2×, 4×, 8×, 80×, etc. The content server takes a transmission stream and generates a rewind stream. According to various embodiments, the rewind stream includes a portion of each GOP or a portion of a subset of the GOPs in a media stream in the reverse direction. In particular embodiments, playback RTP packet stream 501 includes multiple packets having timestamps 503, sequence numbers 505, markets 507, and data portions 509. The packets with time stamps 6, 6, 6, 7, 8, 9, 10, 11, 11, 12, 13, 14, 15, and 16 are associated with timestamps 4303, 4304, 4305, 4306, 4307, 4308, 4309, 4310, 4311, 4312, 4313, 4314, 4315, and 4316. According to various embodiments, each GOP includes a key frame and multiple predicted frames such as P frames and B frames. It should be noted that several packets may be needed to hold a single frame, particular I frames which are larger as they hold data associated with a full picture and not merely differential data.

According to various embodiments, the content server generates a rewind stream in response to the rewind request. The rewind stream 511 includes timestamps 513, sequence numbers 515, markers 517, and data portions 519. The packets with timestamps 11, 11, 12, 13, 6, 6, 6, 7, and 8, are associated with timestamps 4310, 4311, 4312, 4313, 4314, 4303, 4304, 4305, 4306, and 4307. It should be noted that most recent GOPs are played before older GOPs, although frames in each GOP are still played in the forward direction. Frames associated with timestamps 9, 10, 14, 15, and 16 are removed. That is, portions of each GOP are removed. Consequently, an 11 frame sequence is reduced to a 6 frame sequence that is run in about half the time in the reverse direction. As noted above, the GOPs are ordered in the reverse direction, but the frames within each GOP are still played in the forward direction during rewind to allow a client device to obtain a key frame before decoding predicted frames. The client device can then generate discernible output. According to various embodiments, prior to transmitting the sequence, the timestamps are updated to be sequential. Instead of 11, 11, 12, 13, 6, 6, 6, 7, 8, the timestamps would be 6, 6, 6, 7, 8, 9, 9, 10, 11. Similarly, the sequence numbers are also updated to be sequential. It should be noted that the packets shown are only provided as examples. For example, typical GOPs may include many more predicted frames per key frame than those shown.

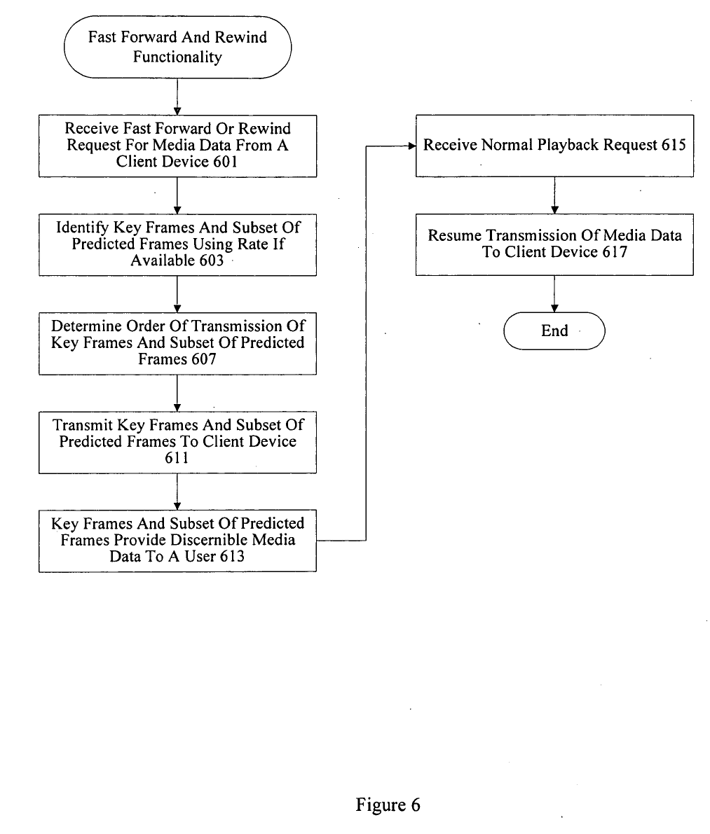

FIG. 6 is a flow process diagram showing one example of a technique for performing remote fast forward and rewind. According to various embodiments, a content server receives a fast forward or a rewind request for media data from a client device at 601. In particular embodiments, the request is included in an RTSP query command, a command that is not conventionally configured to send fast forward or rewind requests. The request may include fields such as a time index, a rate, a direction, a media data identifier and/or a client identifier. At 603, key frames such as I frames and a subset of the predicted frames such as B frames and P frames are identified. According to various embodiments, half of the frames in each GOP including the key frame are selected when the fast forward or rewind rate is 2×. According to various embodiments, a quarter of the frames in each GOP including the key frame are selected when the fast forward or rewind rate is 4×. According to various embodiments, a quarter of the frames in every other GOP are selected when the rewind rate is 8×. A variety of ratios can be used to select portions of streams for transmission. The predicted frames in each GOP selected do not necessarily have to be sequential.

According to various embodiments, the content server determines the order of transmission of the key frames and the subset of predicted frames at 607. In particular embodiments, in the fast forward direction, selected GOPs and selected frames within each GOP are transmitted in sequential order. In particular embodiments, in the reverse direction, selected GOPs are transmitted in reverse order but selected frames within each GOP are transmitted in sequential order. According to various embodiments, sequence numbers and timestamps are adjusted in the media stream to account for the modified transmission order. In some examples however, timestamps and sequence numbers do not need to be reordered.

At 611, key frames and a subset of predicted frames are transmitted to the client device. According to various embodiments, the client device decodes and plays the modified media stream as though it were the original media stream. No accelerated processing is required, although some client may perform additional processing if desired. At 613, key frames and the subset of predicted frames provide discernible media data to a user. The user can view the media stream as the media is being navigated. At 615, a content server receives a normal playback request from the client device. The normal playback request may be included in an RTSP query command and may result from a user pressing a play button. At 617, media data transmission to the client devices resumes.

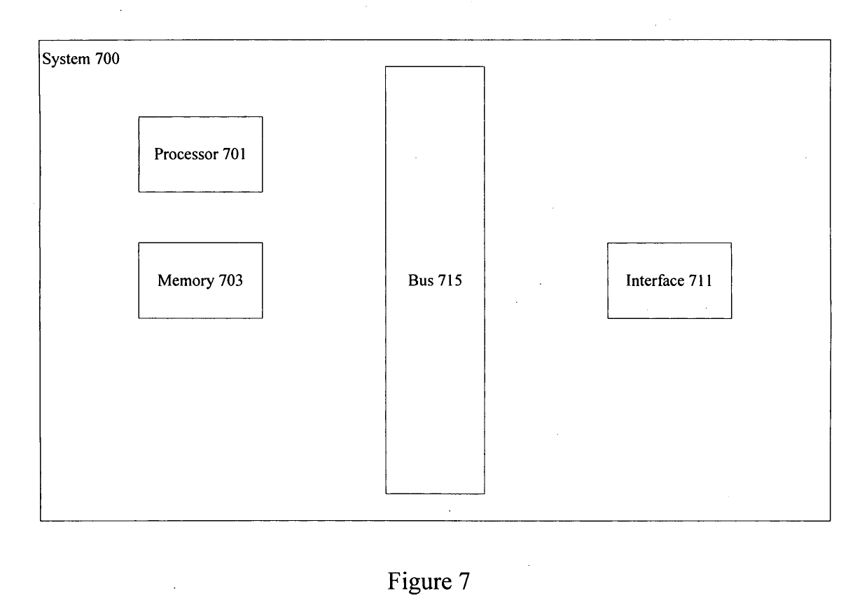

FIG. 7 illustrates one example of a content server. According to particular embodiments, a system 700 suitable for implementing particular embodiments of the present invention includes a processor 701, a memory 703, an interface 711, and a bus 715 (e.g., a PCI bus or other interconnection fabric) and operates as a streaming server. When acting under the control of appropriate software or firmware, the processor 701 is responsible for modifying and transmitting live media data to a client. Various specially configured devices can also be used in place of a processor 701 or in addition to processor 701. The interface 711 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 700 is a content server that also includes a transceiver, streaming buffers, and a program guide database. The content server may also be associated with subscription management, logging and report generation, and monitoring capabilities. In particular embodiments, functionality for allowing operation with mobile devices such as cellular phones operating in a particular cellular network and providing subscription management. According to various embodiments, an authentication module verifies the identity of devices including mobile devices. A logging and report generation module tracks mobile device requests and associated responses. A monitor system allows an administrator to view usage patterns and system availability. According to various embodiments, the content server 791 handles requests and responses for media content related transactions while a separate streaming server provides the actual media streams.

Although a particular content server 791 is described, it should be recognized that a variety of alternative configurations are possible. For example, some modules such as a report and logging module 753 and a monitor 751 may not be needed on every server. Alternatively, the modules may be implemented on another device connected to the server. In another example, the server 791 may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method, comprising:
receiving a rewind request from a client device at a content server, the rewind request associated with media data transmitted from the content server to the client device, the media data including a first group of pictures (GOP) comprising a first key frame and a first plurality of predicted frames, the media data further including a second group of pictures (GOP) comprising a second key frame and a second plurality of predicted frames, the second group of pictures sequenced for transmission after the first group of pictures during playback of the media data;
selecting the second key frame and a subset of the second plurality of predicted frames;
selecting the first key frame and a subset of the first plurality of predicted frames;
transmitting the second key frame and the subset of the second plurality of predicted frames before the first key frame and the subset of the first plurality of predicted frames to respond to the rewind request.

2. The method of claim 1, wherein the rewind request includes a time index

3. The method of claim 1, wherein the rewind request further includes a rewind rate.

4. The method of claim 1, wherein the proportion of frames transmitted in the second plurality of predicted frames and the first plurality of predicted frames is dependent on the rewind rate.

5. The method of claim 4, wherein the proportion of frames transmitted in the second plurality of predicted frames and the first plurality of predicted frames is inversely proportional to the rewind rate.

6. The method of claim 1, wherein the frames are processed for rewind play on the client device in the following order: second key frame, subset of the second plurality of predicted frames, first key frame, subset of the first plurality of predicted frames.

7. The method of claim 1, wherein the client device is a mobile phone.

8. The method of claim 1, wherein the media data is a media stream.

9. The method of claim 8, wherein the media stream is a Real-Time Transport Protocol (RTP) stream.

10. The method of claim 1, wherein the content server is connected over a network to a controller operable to establish a session with the client device using a Real-Time Streaming Protocol (RTSP).

11. The method of claim 10, wherein the rewind request is an RTSP query request.

12. A content server, comprising:
an interface operable to receive a rewind request from a client device at the content server, the rewind request associated with media data transmitted from the content server to the client device, the media data including a first group of pictures (GOP) comprising a first key frame and a first plurality of predicted frames, the media data further including a second group of pictures (GOP) comprising a second key frame and a second plurality of predicted frames, the second group of pictures sequenced for transmission after the first group of pictures during playback of the media data;
a processor operable to select the second key frame and a subset of the second plurality of predicted frames and select the first key frame and a subset of the first plurality of predicted frames;
wherein the interface is further operable to transmit the second key frame and the subset of the second plurality of predicted frames before the first key frame and the subset of the first plurality of predicted frames to respond to the rewind request.

13. The method of claim 12, wherein the rewind request includes a time index

14. The method of claim 12, wherein the rewind request further includes a rewind rate.

15. The method of claim 12, wherein the proportion of frames transmitted in the second plurality of predicted frames and the first plurality of predicted frames is dependent on the rewind rate.

16. The method of claim 15, wherein the proportion of frames transmitted in the second plurality of predicted frames and the first plurality of predicted frames is inversely proportional to the rewind rate.

17. The method of claim 12, wherein the frames are processed for rewind play on the client device in the following order: second key frame, subset of the second plurality of predicted frames, first key frame, subset of the first plurality of predicted frames.

18. The method of claim 12, wherein the client device is a mobile phone.

19. The method of claim 12, wherein the media data is a media stream.

20. An apparatus, comprising:
means for receiving a rewind request from a client device at a content server, the rewind request associated with media data transmitted from the content server to the client device, the media data including a first group of pictures (GOP) comprising a first key frame and a first plurality of predicted frames, the media data further including a second group of pictures (GOP) comprising a second key frame and a second plurality of predicted frames, the second group of pictures sequenced for transmission after the first group of pictures during playback of the media data;
means for selecting the second key frame and a subset of the second plurality of predicted frames;
means for selecting the first key frame and a subset of the first plurality of predicted frames;
means for transmitting the second key frame and the subset of the second plurality of predicted frames before the first key frame and the subset of the first plurality of predicted frames to respond to the rewind request.
